(19) United States
(12) Patent Application Publication
(10) Pub. No.: US 2010/0041778 A1
(43) Pub. Date: Feb. 18, 2010

(54) RECONFIGURABLE POLYMERIC FOAM STRUCTURE

(75) Inventors: Mark S. Lake, Erie, CO (US); Michael Hulse, Erie, CO (US); Douglas Campbell, Longmont, CO (US); Will Francis, Lyons, CO (US); Steven C. Arzberger, Denver, CO (US); Michael Terifay, Longmont, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Composite Technology Development, Inc., Lafayette, CO (US)

(21) Appl. No.: 12/191,657

(22) Filed: Aug. 14, 2008

(51) Int. Cl. C08J 9/00

(52) U.S. Cl. 521/50

(57) ABSTRACT

Methods, systems, and devices are described for fluid-dynamic structures operable to be reconfigured during use. Embodiments of the fluid-dynamic structures include a number of reconfigurable members separated by non-reconfigurable members. The reconfigurable members may be manufactured from temperature-sensitive polymeric foam, which become compliant at certain temperatures. The structure may also include an actuator assembly, operable to apply a reconfiguration force along a reconfiguration path, to reconfigure the structure between two or more volumetric shapes. Some embodiments also include a temperature regulation assembly for regulating the temperature of the reconfigurable members, and a structural attachment assembly for attaching the structure to a structure.

### BACKGROUND

The present invention relates to reconfigurable materials in general and, in particular, to fabrication and use of reconfigurable materials. For example, wings, rudders, rotor blades, fins, or other structural elements that may be re-sized and re-shaped during operation to maximize speed, control, or efficiency for a variety of operational conditions.

It may be desirable, for example, to design a military aircraft, which can “cruise” at moderate speeds for long distances with high fuel-efficiency over friendly territory (e.g., from a naval carrier to an inland battle), “loiter” at slow speeds while awaiting engagement, and “dash” at high speeds for shorter periods of time, to execute a mission or avoid damage from enemy forces. Typically, a single wing design for such an aircraft may be determined by a compromise between these varying flight regimes, allowing the aircraft to operate, albeit sub-maximally, in each condition. These design compromises may be common in aircraft, watercraft, spacecraft, automobiles, buildings, antennae, and other applications, which experience changing fluid-dynamic conditions.

A number of attempts have been made in the art to manufacture reconfigurable structures with desirable fluid-dynamic properties. For example, many current aircraft employ reconfigurable wings, which are comprised of complex assemblies of multiple mechanically actuated rigid structural elements (e.g., main wing, leading-edge slats, trailing-edge flaps, etc.), which can be moved relative to one another to change the aerodynamic performance of the wing. These reconfigurable systems can be complex, expensive, failure-prone, and limited to a small range of reconfigurable modes. Furthermore, these reconfigurable systems tend to exhibit penalties in aerodynamic efficiency (e.g., increased drag) due to discontinuities and irregularities in the resulting aerodynamic surface.

To address some of these limitations, attempts have been made to employ inflatable members to reconfigure fluid-dynamic structural elements during use. Although these concepts tend to be mechanically simple, inflatables have tended to exhibit poor dimensional repeatability, poor aerodynamic characteristics during reconfiguration, and limited strength and stiffness. These issues limit the effectiveness of inflatables under the high fluid-dynamic forces experienced by certain applications, like airplane wings.

Other efforts have been made to develop reconfigurable fluid-dynamic structures with continuous, flexible skins driven by internal articulating mechanical structures. These systems require a stiff, yet highly deformable skin. Most efforts to date have employed skins that are made of rubber, corrugated metal, or other materials that can be stretched to relatively high strains. However, these skin materials tend to buckle, wrinkle, or experience other undesirable out-of-surface deformations during reconfiguration.

More recently, some have attempted to use polymeric foams to create reconfigurable fluid-dynamic surfaces. To date, however, these attempts have tended to face a tradeoff between providing sufficient compressibility to accommodate a useful degree of structural reconfiguration, while providing sufficient strength, stiffness, and surface smoothness to provide good fluid-dynamic performance. For example, open cell foams are highly compressible, but can allow internal fluid flow. Using open cell foams, then, may allow for extensive reconfigurability of a structure, but may fail to provide desirable fluid-dynamic properties. Closed cell foams, however, tend to resist internal fluid flow, but lower compressibility. As such, closed cell foams may be capable of providing desired fluid-dynamic properties, but may not be sufficiently reconfigurable.

Some approaches attempt to address these issues by using open cell foams (e.g., for their high compressibility), but covering them with a secondary skin (e.g., for increased tortuosity). Other prior art approaches drill holes in closed cell foams (e.g., to add compressibility while preserving compression strength), but again covering them with continuous secondary skins creating an impermeable barrier. As discussed above, however, use of a secondary skin may yield undesirable effects. For example, reconfiguration may result in undesirable out-of-surface deformations during reconfiguration (e.g., necking, bulging, wrinkling, etc.), increased failures (e.g., the skin may fracture or lose integrity over time), increased cost (e.g., the skin may increase the number of parts and materials needed for manufacture of the structure, increase the complexity of manufacture, assembly, and repair, etc.), etc.

Finally, the high-strain deformation of large volumes of polymeric foam may result in undesirable out-of-surface deformations. Further, it may be very difficult to manufacture large volumes or complex shapes of foam with high reliability and repeatability. For example, densities and other properties of the foam may be highly variable across large volumes. These variations may affect how different portions of the foam volume may reconfigure, how they may respond to fluid-dynamic forces, and how precisely they may be designed.

Thus, there may be a need in the art for practical designs and techniques for the manufacture of reconfigurable structures, which employ polymeric foams as reconfigurable surfaces and can be used as effective fluid-dynamic structures.

### SUMMARY

Methods, systems, and devices are described for manufacturing and providing reconfigurable fluid-dynamic structures incorporating polymeric foam. Some embodiments of the invention provide structural assemblies, which use polymeric foam to create reconfigurable surfaces with desirable fluid-dynamic properties. Other embodiments of the invention provide methods for designing and manufacturing reconfigurable structures.

In one exemplary embodiment, an aircraft wing is provided, which is configured for span-wise length change. The wing includes an internal telescoping-spar mechanism that is enveloped by a reconfigurable airfoil structure comprised of a number of reconfigurable members made of polymeric foam configured to be expanded or contracted in the span-wise direction. The polymeric foam may also be configured to provide a sufficient tortuosity (i.e., internal resistance to air flow) to be useful as an airfoil without the need for a secondary skin. Furthermore, the wing may include a temperature regulation assembly, configured to heat the polymer foam to prescribed temperatures in order to control stiffness and strength of the foam. Each reconfigurable foam member is separated by a rigid rib member coupled with the telescoping spar; and a rigid bulkhead member is provided at the outermost end of the wing. The telescoping spar may be configured to drive the reconfigurable foam members, by exerting force on the bulkhead member, and the telescoping spar may serve to guide the motion of the reconfigurable foam members.

In one set of embodiments, a method for producing a reconfigurable fluid-dynamic structure is provided. The method includes determining a set of design specifications for the fluid-dynamic structure, having: a reconfiguration direction, being a direction in which the fluid-dynamic structure is designed to be reconfigured; and a reconfiguration force, being an amount of force the fluid-dynamic structure is designed to receive in the reconfiguration direction to undergo a reconfiguration. The method further includes selecting a foam type at least as a function of a foam specification, the foam specification being selected from a group consisting of: a compliance direction, being a direction in which the foam type is substantially compliant; and a compliance level, being determined as a function of how compliant the foam type is when subjected to a compliance force in the compliance direction; designing a reconfigurable member, the reconfigurable member being manufactured from the selected foam type and having a slice width, the slice width being a dimension of the reconfigurable member oriented in the compliance direction; and designing an actuator assembly adapted to apply the reconfiguration force to the fluid-dynamic structure by applying the reconfiguration force to at least a portion of a plurality of reconfigurable members when the reconfigurable members are coupled with the actuator assembly such that the compliance direction of the reconfigurable members is aligned with the reconfiguration direction of the fluid-dynamic structure.

In another set of embodiments, a method for producing a reconfigurable fluid-dynamic structure is provided. The method includes orienting a first quantity of reconfigurable members in a reconfiguration direction, wherein each of the reconfigurable members is manufactured from a material adapted to be substantially compliant in the reconfiguration direction; sandwiching a non-reconfigurable member between each of the reconfigurable members, each of the non-reconfigurable members being manufactured from a substantially non-compliant material; forming a reconfigurable fluid-dynamic structure by operatively coupling at least a portion of the non-reconfigurable members with an actuator system, the actuator system being adapted to provide a reconfiguration force in the reconfiguration direction, wherein coupling the portion of the non-reconfigurable members to the actuator system comprises configuring the reconfigurable fluid-dynamic structure to transition from a first volumetric shape to a second volumetric shape at least along the reconfiguration direction when the reconfiguration force is applied by the actuator system. In some embodiments, a reconfigurable fluid-dynamic structure manufactured by the method is provided.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A provides an illustrative non-reconfigured view of a reconfigurable aircraft wing.

FIG. 1B provides an illustrative reconfigured view of a reconfigurable aircraft wing.

FIG. 2 shows an illustrative embodiment of a reconfigurable aircraft wing, according to various embodiments of the invention.

FIG. 3A shows an exemplary fluid-dynamic structure reconfiguring in a chord-wise direction, according to various embodiments of the invention.

FIG. 3B shows an exemplary fluid-dynamic structure reconfiguring in a span-wise direction, according to various embodiments of the invention.

FIG. 3C shows an exemplary fluid-dynamic structure reconfiguring in a shear-wise direction, according to various embodiments of the invention..

FIG. 4 shows a simplified block diagram of an embodiment of a reconfigurable fluid-dynamic structure, according to various embodiments of the invention.

FIG. 5 provides illustrations of one type of undesirable out-of-surface deformation response due to coupling in the elastic response of a polymeric-foam reconfigurable member in directions parallel to and perpendicular to the direction of reconfiguration, according to various embodiments of the invention.

FIGS. 6A and 6B provide illustrations of another type of undesirable out-of-surface deformation response due to buckling of a polymeric-foam reconfigurable member, according to various embodiments of the invention.

FIG. 7A shows an idealized reconfigurable fluid-dynamic structure having two reconfigurable members separated by non-reconfigurable members, according to various embodiments of the invention.

FIG. 7B shows a similarly sized reconfigurable fluid-dynamic structure having six reconfigurable members separated by non-reconfigurable members, according to various embodiments of the invention.

FIG. 8 shows an embodiment of a reconfigurable structure having portions of the reconfigurable members selectively removed to reduce the effects of certain types of deformations, according to various embodiments of the invention.

FIG. 9A illustrates one manufacturing process for a reconfigurable member 920 that begins with an uncompressed block of polymeric foam, according to various embodiments of the invention.

FIG. 9B shows a manufacturing process that begins with a block of polymeric foam 910 that is compressed into a compressed foam sheet, according to various embodiments of the invention.

FIG. 10 provides a flow diagram of a method for designing a reconfigurable fluid-dynamic structure, according to various embodiments of the invention.

FIG. 11 provides a flow diagram of a method for manufacturing a reconfigurable fluid-dynamic structure, according to various embodiments of the invention.

FIG. 12A shows an exemplary flow diagram of methods for reconfiguring a non-temperature-reactive fluid-dynamic structure, according to various embodiments of the invention.

FIG. 12B shows an exemplary flow diagram of methods for reconfiguring a temperature-reactive fluid-dynamic structure, according to various embodiments of the invention.

### DETAILED DESCRIPTION OF THE INVENTION

This description provides exemplary embodiments only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Systems, devices, and methods are described for manufacturing and providing reconfigurable-foam fluid-dynamic structures. Some embodiments of the invention provide structural assemblies, which use polymeric foam, to create reconfigurable surfaces with desirable fluid-dynamic properties. Other embodiments of the invention provide methods for the design and manufacture of such reconfigurable structural assemblies that may lead to improved fluid-dynamic performance at decreased overall cost and weight.

### Exemplary Structural Embodiments

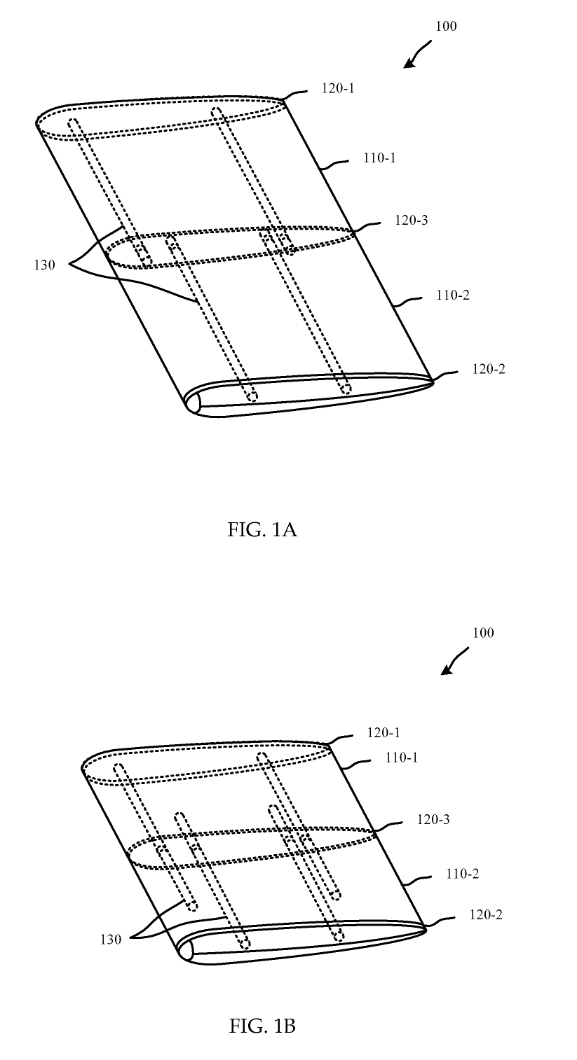

One set of embodiments provides reconfigurable fluid-dynamic structures that use polymeric foam to enable large volumetric and shape changes, while providing desirable fluid-dynamic properties. The reconfigurable structures may be designed for use with any number of applications, including aircraft, rotorcraft, boats, spacecraft, automobiles, shelters, or any other structure with at least one surface designed to have fluid-dynamic characteristics. For example, FIGS. 1A and 1B provide illustrative non-reconfigured and reconfigured views of a reconfigurable aircraft wing, respectively. The aircraft wing 100 includes two reconfigurable-foam members 110, three non-reconfigurable members 120, and rib members 130. The reconfigurable-foam members 110 are manufactured from a polymeric foam.

A first non-reconfigurable member 120-1 is coupled with a first reconfigurable-foam member 110-1 and two sliding-actuator members 130, and is configured to attach the aircraft wing 100 to an aircraft structure. A second non-reconfigurable member 120-2 is coupled with a second reconfigurable-foam member 110-2 and another two sliding-actuator members 130, and is configured to provide an aerodynamic end to the aircraft wing 100 surface. A third non-reconfigurable member 120-3 is sandwiched between the first reconfigurable member 110- 1 and the second reconfigurable member 110-2, and is configured to allow the sliding-actuator members 130 to pass through.

For thermally-activated polymer foam reconfigurable members (e.g., shape-memory polymer foam), the reconfigurable members 110 are heated prior to changing shapes (e.g., from the shape of FIG. 1A to the shape of FIG. 1B, or vice versa). After shape change, the reconfigurable-foam members are allowed to cool. A heating system for the foam may be partially or completely located on the non-reconfigurable members (120-1, 120-2, 120-3), and may transmit heat energy into the foam members through any direct or indirect means (e.g., surface conduction, electrical-current transmission, electromagnetic-energy transmission, etc.).

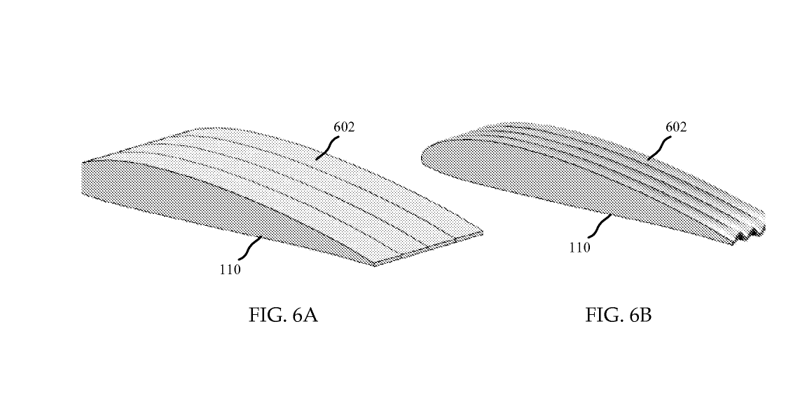

It will be appreciated that the number, shape, distribution, and other characteristics of reconfigurable and non-reconfigurable members may vary, according to different embodiments of the invention. Further, it will be appreciated that these variances may be determined as a function of certain considerations, including those described herein (e.g., with respect to FIG. 6). Further, while the reconfigurable members and the non-reconfigurable members will be shown in various embodiments as coupled or not coupled to each other, these illustrated configurations are intended merely for the sake of clarity. As such, the number, character and configurations of the reconfigurable and non-reconfigurable members, as described with reference to various embodiments herein, should not be construed as limiting the scope of the invention.

Furthermore, it will be appreciated that terms, including “reconfigurable,” “non-reconfigurable,” “compliant,” and “non-compliant,” are intended to be relative and application specific. After all, all materials may be “reconfigurable” or “compliant” to some extent in certain environments (e.g., metals may be bent or deformed with sufficient force or under high temperatures). As such, the non-reconfigurable members 120 are “non-reconfigurable” inasmuch as they are significantly less compliant than the reconfigurable members 110 in their compliant state. Similarly, depending on the application, the non-reconfigurable members 120 may be more, less, or equivalently compliant than the reconfigurable members 110 in their non-compliant state.

Moreover, some embodiments are described as being reconfigurable from a first volumetric shape to a second volumetric shape. In certain of these embodiments, the first and second volumetric shapes define the extreme reconfiguration conditions of the structure. In others of these embodiments, the first and second volumetric shapes define a subset of possible reconfiguration conditions of the structure. In still others of these embodiments, the first and second volumetric shapes define reconfiguration conditions between which are one or more additional reconfiguration conditions.

For example, in one set of embodiments, a reconfigurable aircraft wing is provided that is adapted to be reconfigured from a first wingspan to a second wingspan. In one embodiment, certain wing members include temperature-sensitive reconfigurable foam. To conserve energy, subsets of the foam members may be heated and reconfigured in stages. In another embodiment, the wing may be reconfigured to one or more of various intermediate wingspans between the first wingspan and the second wingspan (e.g., to dynamically account for different environmental and/or flight conditions).

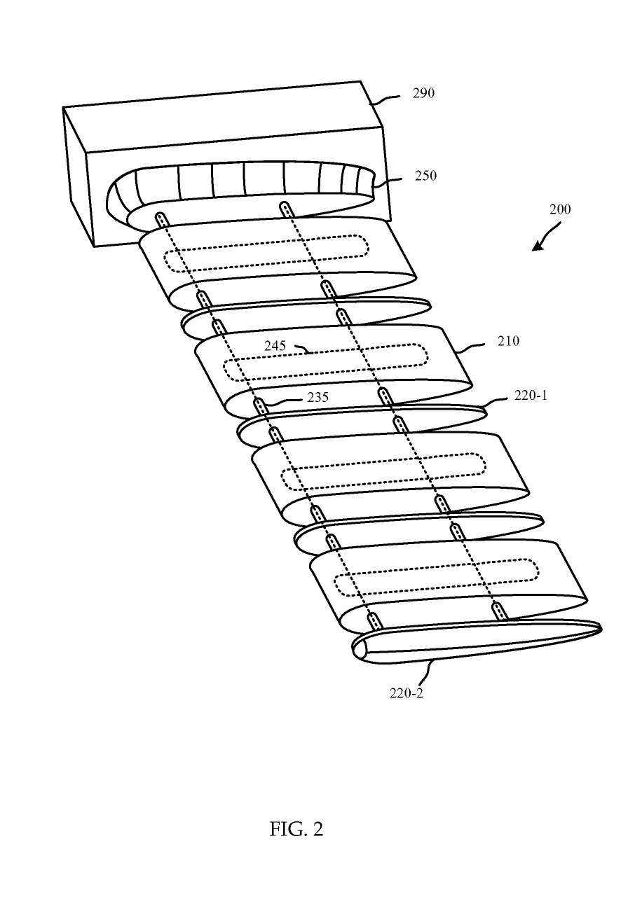

FIG. 2 shows an illustrative embodiment of a reconfigurable aircraft wing, according to various embodiments of the invention. For illustrative purposes, the aircraft wing shown in FIG. 2 includes a greater number of reconfigurable members 210 and non-reconfigurable members 220, than the wing shown in FIG. 1. While the reconfigurable members 210 and non-reconfigurable members 220 may be coupled with each other, they are shown as separate merely for illustrative clarity.

Two telescoping members 235 run the span-wise length of the aircraft wing 200 and are configured to apply a unidirectional reconfiguration force to the aircraft wing 200 in the span-wise direction. The telescoping members 235 are coupled to the base of the aircraft wing 200 (within the structural attachment assembly 250), and to a non-reconfigurable member 220-2 at the end of the aircraft wing 200 (which is shaped to continue the airfoil shape to the wingtip). If necessary, heating elements might be integrated into the non-reconfigurable members 220, or within the reconfigurable members 245.

In some embodiments, at least a portion of the non-reconfigurable members 220 may be rib-like members (e.g., non-reconfigurable member 220-1). In certain embodiments, the rib-like non-reconfigurable members 220 act as slidable spacers, which may help couple reconfigurable members 210 with one another or to form certain shapes. For example, non-reconfigurable members 220 may be shaped to add structure and contour to a fluid-dynamic structure while restricting the shape of the reconfigurable members 210 during reconfiguration, and minimizing undesirable deformations in the reconfigurable members, as will be discussed later. This may allow the use of standard-shaped reconfigurable members 210, or reconfigurable members 210 shaped to be reconfigured in certain directions, even where those shapes do not match the desired shape of the structure.

In other embodiments, the non-reconfigurable members 220 may be used as attachment points for other components and/or structural elements. In one embodiment, metal surface reinforcements may be suspended just above the surface of the reconfigurable members 210, flight control surfaces may be provided, etc. In another embodiment, heating and/or actuation elements are coupled with the non-reconfigurable members (e.g., to increase the efficacy of reconfiguring the structure).

In still other embodiments, the non-reconfigurable members 220 act as load transfer elements. For example, as the aircraft wing 200 experiences fluid-dynamic loads, it may be desirable to transfer those loads to the main structure 290. The rigid non-reconfigurable members 220 may transfer the load from the reconfigurable members through the telescoping members 235, through the structural attachment assembly 250, and into the structure 290. It will be appreciated that in some applications, larger numbers of non-reconfigurable members 220 may be used to transfer loads depending on the shape and size of the structure. For example higher fluid dynamic loads, resulting from higher aircraft weight and/or flight dynamics, may require the use of a larger number of non-reconfigurable members to adequately transfer load into the structure.

A reconfiguration force may be applied to the aircraft wing 200 by extending the telescoping members 235, essentially pushing the non-reconfigurable member 220-2 further from the base of the aircraft wing 200. Because the reconfigurable members 210 and the non-reconfigurable members 220 are coupled with one another, and because the reconfigurable members 210 and the non-reconfigurable members 220 are slidably coupled with the telescoping members 235; pushing the non-reconfigurable member 220-2 may stretch each of the coupled reconfigurable members 210, thereby stretching the aircraft wing 200 to a new volumetric shape. For thermally-sensitive foams, the wing may then be cooled in this new shape.

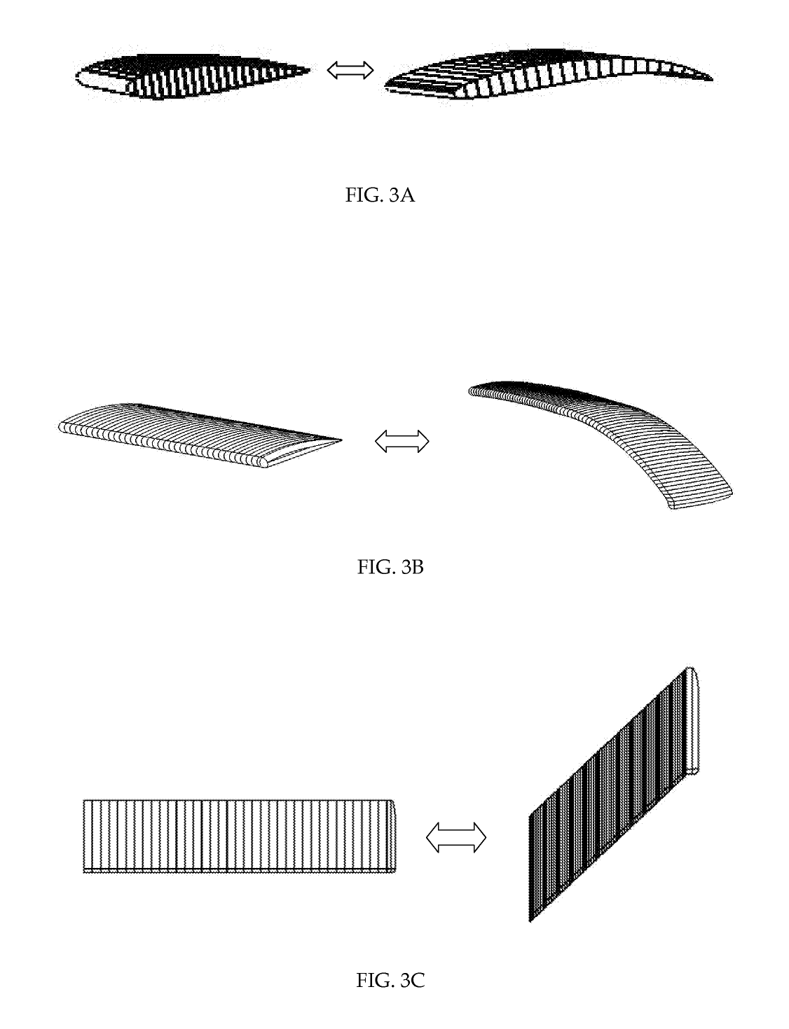

Some exemplary illustrations of different reconfiguration modes and paths are shown in FIGS. 3A-3C. FIG. 3A shows an exemplary airfoil/hydrofoil reconfiguring in a chord-wise direction in order to change both the chord dimension and the camber of the airfoil/hydrofoil. It is worth noting that the airfoil/hydrofoil is configured such that, during the chord-wise morphing, the overall volumetric shape of the structure also changes from symmetrical to asymmetrical for added fluid-dynamic effect. FIG. 3B shows an exemplary airfoil/hydrofoil reconfigured to create a bent profile in a span-wise direction. FIG. 3C shows an exemplary airfoil/hydrofoil reconfigured to create a sweep angle in the span-wise direction.

It is worth noting that the reconfigurable structure may be part of a larger structure. In some embodiments, the reconfigurable structure is an appendage to a second structure (e.g., a reconfigurable wing attached to a non-reconfigurable aircraft fuselage). In other embodiments, the reconfigurable structure is one or more sections of a larger structure. In one embodiment, an aircraft wing includes a central reconfigurable section, where other sections of the wing are non-reconfigurable. In another embodiment, an aircraft wing comprises mostly non-reconfigurable structure, but includes a chord-wise expanding reconfigurable section along the trailing edge of the wing (e.g., to act as a reconfigurable flight control surface).

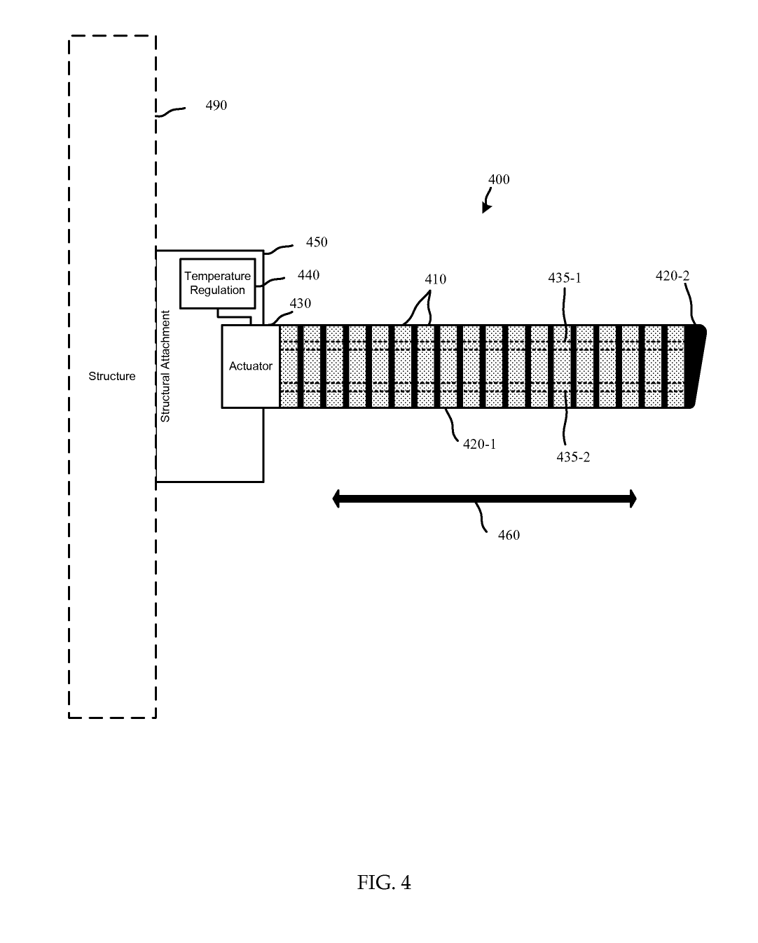

FIG. 4 shows a simplified block diagram of an embodiment of a reconfigurable fluid-dynamic structure, according to various embodiments of the invention. The structure 400 includes a number of reconfigurable members 410, a number of non-reconfigurable members 420, an actuator assembly 430, a temperature regulation assembly 440, and a structural attachment assembly 450 for attaching the structure 400 to a second structure 490.

The reconfigurable members 410 may be manufactured of any polymeric foam material with a thermoset, thermoplastic, or non-temperature-reactive chemistry; have open-cell or closed-cell microstructure; and may or may not have shape-memory characteristics. In some embodiments, the reconfigurable members 410 are manufactured of temperature-sensitive polymeric foam, designed to operate in a substantially non-compliant state when exposed to a first temperature level (e.g., below a first temperature threshold), and to operate in a substantially compliant state when exposed to a second temperature level (e.g., above a second temperature threshold). In the compliant state, the reconfigurable members 410 may be reconfigured from one volumetric shape to another volumetric shape. In these embodiments, the reconfigurable fluid-dynamic structure incorporates a temperature regulation assembly 440 to control the temperature of the foam members.

In some embodiments, the reconfigurable foam members 410 are manufactured such that they provide high tortuosity at least in regions substantially near the exposed surface of the reconfigurable member. In certain embodiments, the reconfigurable members 410 are manufactured from a type of foam (e.g., a closed cell foam) that may inherently provide high tortuosity throughout the foam volume. In other embodiments, the reconfigurable members 410 are manufactured from a lower-tortuosity foam (e.g., an open cell foam), but are treated for increased tortuosity, such as with a thin coating of a highly stretch-able, yet impermeable material (e.g., a microscopic layer of elastomeric material). In still other embodiments, the reconfigurable members 410 may be manufactured from a foam that varies in different regions to provide hybrid-types of effects. For example, a foam may be used that is manufactured to have low tortuosity in the center, and substantially higher tortuosity toward the surface.

In certain embodiments, different reconfigurable members 410 may be configured to perform differently and/or independently. In one embodiment, a first set of the reconfigurable members 410 in the structure 400 becomes compliant at one temperature and/or through the action of one actuator element 435-1, while a second set of the reconfigurable members 410 becomes compliant only at a second, higher temperature, or through the action of a second actuator element 435-2. In this way, the structure 400 may be reconfigured to a series of intermediate shapes in steps.

Some or all of the reconfigurable members 410 may be coupled with (and may be separated by) at least one non-reconfigurable member 420. In some embodiments, each reconfigurable member is sandwiched between a respective pair of non-reconfigurable members. In certain embodiments, sandwiching the reconfigurable member between non-reconfigurable members includes directly coupling the reconfigurable member to at least one of the non-reconfigurable members; while in other embodiments, sandwiching the reconfigurable member between non-reconfigurable members includes sandwiching other elements between the members (e.g., other reconfigurable or non-reconfigurable members, adhesives, seals, attachment structure, sensors, etc.). The non-reconfigurable members 420 may be manufactured of any useful non-reconfigurable material, depending on the application. For example, in some applications, it may be desirable to manufacture the non-reconfigurable members 420 from metal (e.g., steel, aluminum, titanium, etc.), composite, plastic, or any other non-reconfigurable material.

The actuator assembly 430 may be configured to apply a reconfiguration force to the structure to reconfigure the structure from one volumetric shape to another volumetric shape, and it may be configured to constrain the motion of the reconfigurable members such that they move along a prescribed path during reconfiguration. In the embodiment shown in FIG. 4, the actuator assembly 430 includes two telescoping components 435 that run the span-wise length of the structure 400. In one embodiment, the telescoping components 435 may be used to expand or compress the structure 400 in the span-wise direction (e.g., as shown by arrow 460).

In some embodiments, the reconfiguration force is applied by the actuator assembly 430 in a single direction. For example, a reconfigurable aircraft wing may only reconfigure (e.g., expand) along its chord-wise or span-wise direction. In other embodiments, the reconfiguration force is applied by the actuator assembly 430 in multiple directions simultaneously. For example, a reconfigurable aircraft wing may reconfigure (e.g., expand) simultaneously along both its chord-wise and span-wise directions. In yet other embodiments, the actuator assembly 430 may be configured to apply the reconfiguration force along one or more of a number of directions. For example, a pilot (or flight computer) may be able to reconfigure an aircraft wing's length, width, thickness, camber, sweep, dihedral angle, or any other volumetric parameter, during flight and depending on the circumstances.

It will be appreciated that the reconfiguration force or forces may be applied differently for different types of foam materials and for other reasons. For example, in one embodiment, the foam is compliant and elastic in the direction of reconfiguration, and the reconfigurable members develop a resistive force as the actuator assembly deforms the reconfigurable members in one direction. Hence, the actuator assembly must maintain a static force in order to keep the reconfigurable members deformed, and must relax this force to allow the reconfigurable members to return to their initial configuration. In another embodiment, the foam is a shape-memory material that it is compliant only when its temperature exceeds a threshold temperature level, and can “freeze” induced strain energy when cooled below a certain threshold temperature level. In this embodiment, the actuator may first heat the foam and then push or pull the foam in direction of reconfiguration, as in the preceding embodiment. However, once reconfigured, the foam might be cooled such that the induced strain energy is “frozen” and the need for maintaining a static reaction force in the actuator assembly is eliminated.

It will be appreciated that many types of actuators are known in the art and may be used according to the invention. For example, the actuator may be electromechanical, electromagnetic, pneumatic, hydraulic, spring-loaded, belt-driven, or any other useful actuator. It will further be appreciated that different types of actuators may be useful depending on the type of application and the reconfiguration direction (or directions) desired. For example, very lightweight applications may require lightweight actuators; while structures that must withstand high fluid-dynamic forces may require heavy-duty actuators.

In some embodiments a temperature regulation assembly 440 is included to regulate the temperature of the reconfigurable-foam members. In some embodiments, the temperature regulation assembly 440 includes certain heating elements. For example, the temperature regulation assembly 440 may include electrical heating, chemical heating, fluid (e.g., gas or liquid) heating, or other types of heating components. In other embodiments, the temperature regulation assembly 440 includes components for transmitting, directing, transferring, or otherwise moving heat. For example, the temperature regulation assembly 440 may include conduits, fans, wires, radiators, or other components. In still other embodiments, the heat energy used by the temperature regulation assembly 440 may be recycled or generated from another system. In one example, hot exhaust from a vehicle may be directed to the reconfigurable members 410 to change their temperature. In another example, solar energy may be directed to the reconfigurable members 410 as heat.

It will be further appreciated that there are many ways for the temperature regulation assembly 440 to regulate the temperature of the reconfigurable members 410 according to the invention. In some embodiments, components of the temperature regulation assembly 440 directly contact some or all of the reconfigurable members 410. In one embodiment, wires or pipes run through the reconfigurable members 410 to conduct heat energy through the reconfigurable members 410 and regulate their temperatures. In another embodiment, heating and/or conduction elements are coupled with non-reconfigurable members 420 to deliver heat to portions of the structure 400. In certain other embodiments, components of the temperature regulation assembly 440 are configured to indirectly regulate the temperature of at least a portion of the reconfigurable members 410. For example, blowers may be situated to direct hot air towards the reconfigurable members 410 when desired.

In some embodiments of the structure 400, a structural attachment assembly 450 is provided. The structural attachment assembly 450 may include any one or more component configured to attach the structure 400 to the second structure 490. In certain embodiments, the structural attachment assembly 450 includes custom-fabricated components; while in other embodiments, the structural attachment assembly 450 contains off-the-shelf components. Of course, many types of structural attachment assemblies 450 are possible, depending on the application, without departing from the invention.

It will be appreciated that the description above is intended to be illustrative and should not be construed as limiting the invention. Those skilled in the art will understand that components may be incorporated into other components or separated into subcomponents, reordered, or otherwise reconfigured without departing from the invention.

### Exemplary Method Embodiments

Some embodiments of the invention define methods for the design and/or manufacture of reconfigurable fluid-dynamic structures incorporating polymeric-foam reconfigurable members. Certain of these embodiments may address a number of potential issues that may be inherent in using polymeric foam for reconfigurable fluid-dynamic structures (e.g., those shown in FIGS. 1, 2, and 3), including: undesirable out-of-surface deformations; low stiffness/strength in the compliant state (i.e., during reconfiguration); and potential variations in foam characteristics through the reconfigurable volume due to variations in foam microstructure. With respect to various embodiments, it may be desirable to determine the number and/or arrangement of reconfigurable and non-reconfigurable members in a structure, based on one or more criteria. For example, the number and/or arrangement of reconfigurable and non-reconfigurable members may be determined to maximize the performance of the structure (e.g. fluid-dynamic performance and degree of re-configurability) while minimizing the cost/complexity of the structure.

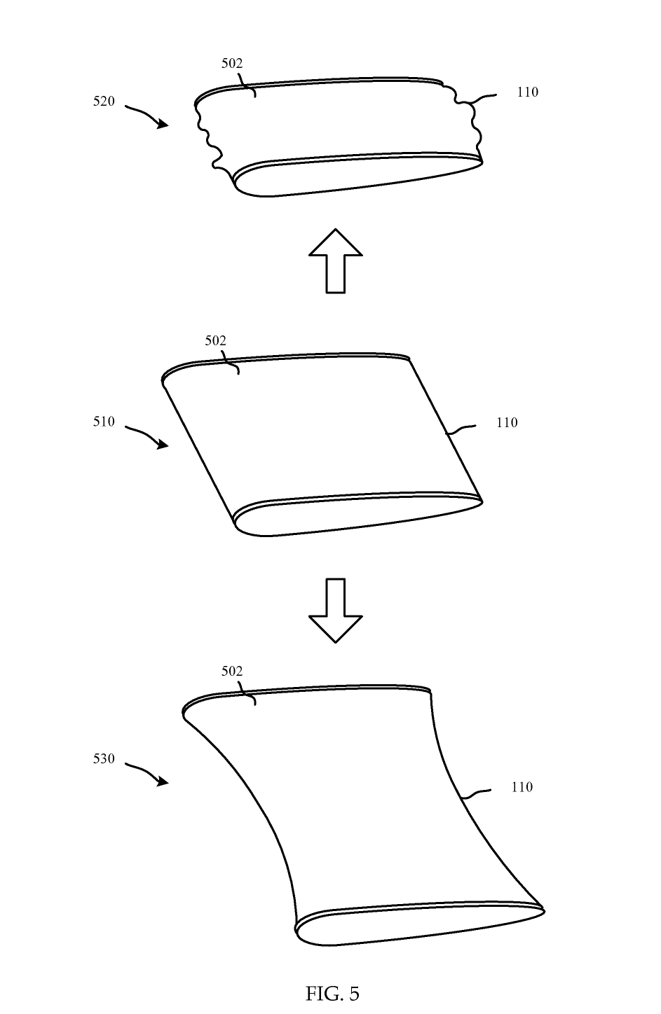

FIG. 5 provides illustrations of one type of undesirable out-of-surface deformation response due to coupling in the elastic response of a polymeric-foam reconfigurable member in directions parallel to and perpendicular to the direction of reconfiguration (e.g., Poisson coupling). As shown, the reconfigurable member 110 may have a steady-state condition 510, a compressed condition 520, and a stretched condition 530. In the steady-state condition 510, the reconfigurable member 110 has a fluid-dynamic surface 502 that is substantially smooth. As the reconfigurable member 110 is compressed into the compressed condition 520, the fluid-dynamic surface 502 deforms (e.g., bulges). Similarly, as the reconfigurable member 110 is stretched into the stretched condition 530, the fluid-dynamic surface 502 deforms (e.g., necks).

FIGS. 6A and 6B provide illustrations of another type of undesirable out-of-surface deformation response due to buckling of a polymeric-foam reconfigurable member. As shown, the reconfigurable member may have a steady-state condition (FIG. 6A), and a compressed condition (FIG. 6B). In the steady-state condition, the reconfigurable member 110 has a fluid-dynamic surface 602 that is substantially smooth. As the reconfigurable member 110 is compressed into the compressed condition, the fluid-dynamic surface 602 deforms due to buckling in regions that are substantially thin (e.g., near the trailing edge of the airfoil).

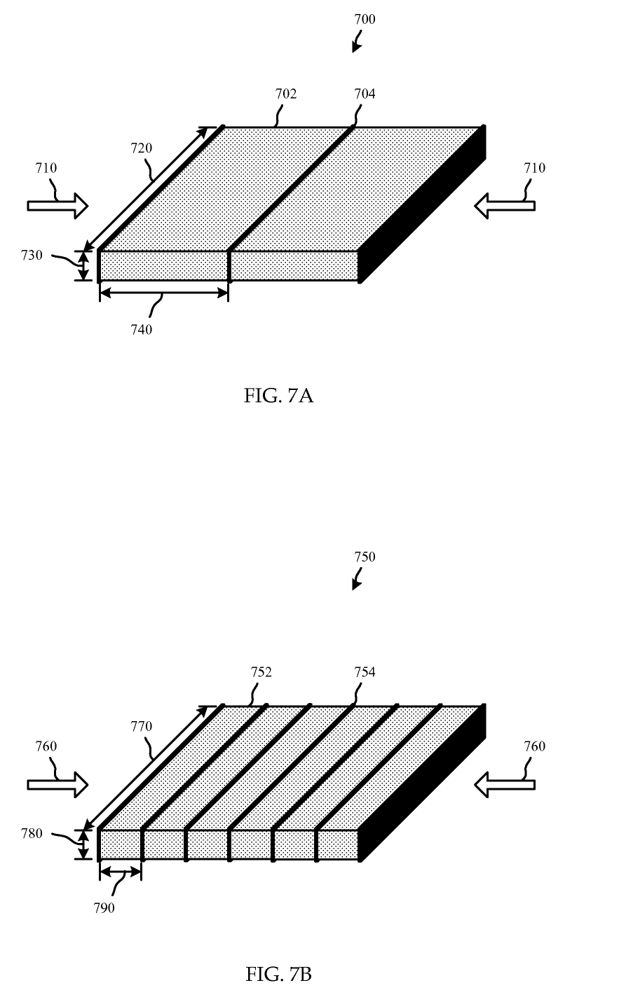

FIGS. 7A and 7B can be used to illustrate exemplary effects of the number of reconfigurable and non-reconfigurable members on these undesirable out-of-surface deformation modes of a structure, which is designed to reconfigure through compression of the reconfigurable-foam members. FIG. 7A shows an idealized reconfigurable fluid-dynamic structure 700 having two reconfigurable members 702 separated by non-reconfigurable members 704. Each reconfigurable member 702 has a width (w) 720, a thickness (t) 730, and a length (L) 740. A reconfiguration force (ε) may be applied in the direction of arrows 710 to compress the reconfigurable members 702.

FIG. 7B shows a similarly sized reconfigurable fluid-dynamic structure 750 having six reconfigurable members 752 separated by non-reconfigurable members 754. Each reconfigurable member 752 has a width (w) 770, a thickness (t) 780, and a length (L) 790. Note that length 790 of the reconfigurable members in FIG. 7B is one-third the length 740 of the reconfigurable members in FIG. 7A.

For illustrative purposes, consider first the effect of the length of the reconfigurable members on their out-of-surface buckling response under uniform compression loading. Consider further the possibility that, under uniform compression loading, the reconfigurable members could buckle according to Euler's buckling equation:

$$P = \frac{{π}^{2} EI}{{L}^{2}} ,$$

where

$$I = \frac{{wt}^{3}}{12} ,$$

and E is the material's Young's modulus. Other related structural formulae give σ=Eε and P=σtw. Substituting into Euler's buckling equation and rearranging terms yields that buckling will occur where:

$$\frac{12 ɛ}{{π}^{2}} ≺ {( \frac{t}{L} )}^{2} .$$

It will be appreciated that, according to Euler's equation, there is an inverse relationship between the compression strain, ε, at which buckling occurs and the square of the length of the reconfigurable members, L. As in the examples provided with relation to FIGS. 7A and 7B, reducing the length of the reconfigurable members (e.g., decreasing the rib spacing) by a factor of three yields a structure that could withstand nine times the reconfiguration strain without buckling.

Of course, while FIGS. 7A and 7B illustrate idealized geometries of reconfigurable members and the Euler buckling condition is only one of many possible buckling modes of response, real-world scenarios may yield similar or identical trends. For example, it may be generalized that reducing the length of reconfigurable members (e.g., by including a greater number of members for a given reconfigurable volume) may reduce the incidence of buckling of the reconfigurable members. Further, in addition to limiting the effects of buckling, it will be appreciated that other deformations, like Poisson's expansion and contraction (e.g., as shown in FIG. 5) may be similarly impacted by changes in the number and length of reconfigurable members.

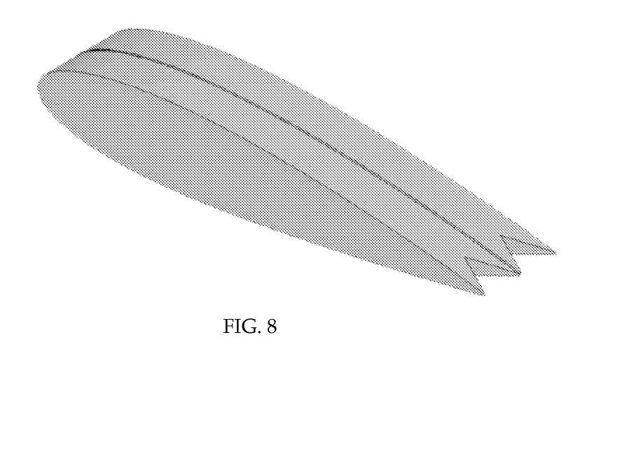

In certain embodiments, the incidence of buckling in regions where the polymer-foam reconfigurable member is substantially thin (e.g., near the trailing edge of a reconfigurable airfoil) is reduced by selectively removing portions of the foam to reduce the total volume of material that must be compressed. This may, in turn, reduce the magnitude of buckling exhibited in these regions. For example, FIG. 8 shows an embodiment of a reconfigurable structure having portions of the reconfigurable members selectively removed to reduce the effects of certain types of deformations.

It is worth noting that using larger numbers of smaller reconfigurable members may limit certain types of deformation caused by fluid-dynamic forces. When fluid-dynamic forces are exerted on a structure (e.g., during flight), the surfaces that comprise the structure may be deformed. For example, fluid-dynamic forces may push on a reconfigurable member, causing it to deform out-of-plane. These deformations may create undesirable fluid-dynamic effects. Furthermore, the magnitude of this deformation may be directly related to the length of the reconfigurable members or the spacing of the non-reconfigurable members. For example, according to Euler beam theory, the maximum deformation (vₘₐₓ) of a beam that is uniformly loaded transverse to its length may be calculated as:

$${v}_{max} = \frac{5 ω {L}^{4}}{384 EI} ,$$

where ω is the uniform load and L is the beam length. Thus, by using larger numbers of smaller reconfigurable members (e.g., by reducing the rib spacing in the structure), the length of the reconfigurable members (L) is decreased, which may exponentially reduce out-of-plane deformations. Ultimately, this may yield improved fluid-dynamics.

Other embodiments of the invention provide methods for maintaining a high degree of consistency and quality in the manufacture of reconfigurable-foam structures. Large volumes of polymeric foam may have inherent limitations. For example, it is generally accepted that the quality and consistencies of large volumes of polymeric foam (e.g., thermoset foam) may be limited by: (1) polymer resin formulation; (2) methods of introducing foam inclusions; (3) control over the fabrication of uniform (or near-uniform) cell sizes; and (4) optimization of appropriate resin gel and cure conditions, which includes the simultaneous balancing of heat transfer, resin chemical rates of reaction, inclusion generation, foam tooling, and selection of appropriate processing methods. As such, by segmenting a structure into larger numbers of smaller foam volumes, each foam volume may exhibit increased quality and consistency. This may allow for more repeatable and reliable designs, and better realization of engineering specifications in the manufactured product.

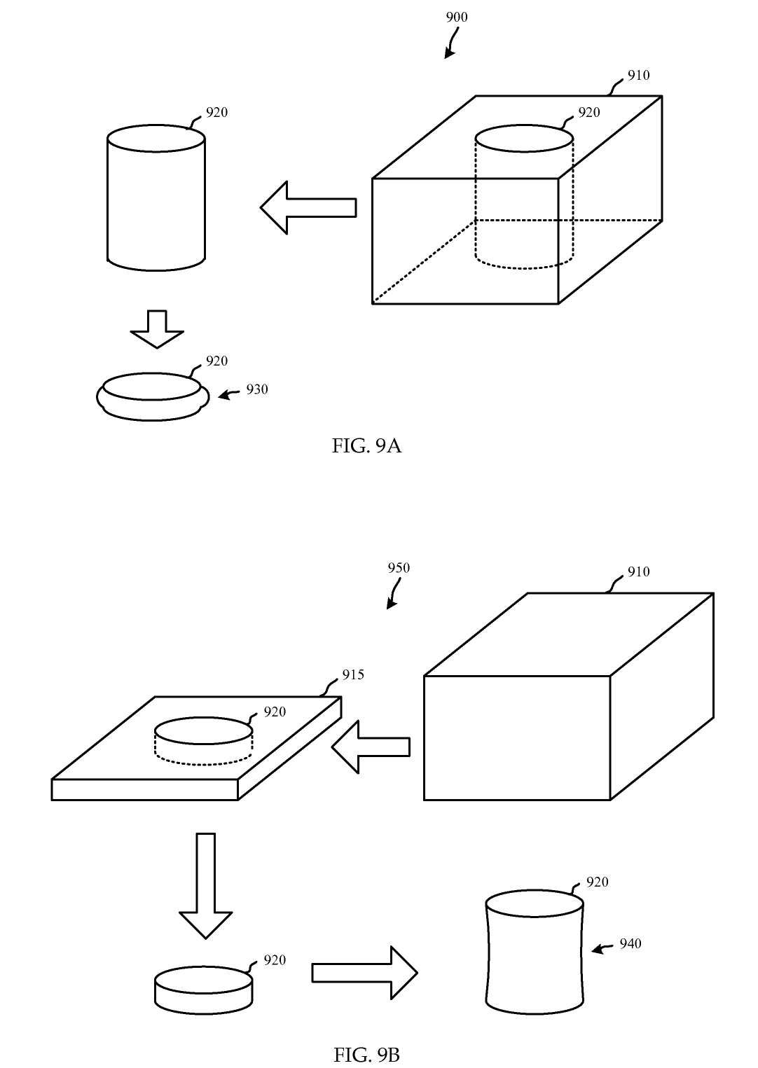

Still other embodiments of the invention provide methods for manufacturing reconfigurable, polymer-foam structure to reduce undesirable impacts on the fluid-dynamic performance of the structure from the foam material's Poisson coupling. FIG. 9A illustrates one manufacturing process 900 for a reconfigurable member 920 that begins with an uncompressed block of polymeric foam 910. A reconfigurable member 920 is cut from the block of polymeric foam 910. The reconfigurable member 920 is then compressed in application and bulging occurs 930.

Alternatively, FIG. 9B shows a manufacturing process 950 that begins with a block of polymeric foam 910 that is compressed into a compressed foam sheet 915. A reconfigurable member 920 is cut from the compressed foam sheet 915. The reconfigurable member 920 is then returned to its original decompressed state in application. Because the reconfigurable member 920 is cut in its compressed state, no bulging may occur when the reconfigurable member is returned to that state. However, when the reconfigurable member 920 is in its decompressed state, there may be necking 940 (i.e., as if the original state is now a “stretched” state.

In selecting the appropriate manufacturing processes, it may be desirable to profile the surface of the foam material in a deformed state that corresponds to a configuration of the reconfigurable member for which fluid-dynamic forces are most sensitive to surface irregularities. For example, the aerodynamic performance of a wing in a particular configuration may be more sensitive to surface roughness due to Poisson effects than the same wing reconfigured to a different shape. Hence, the polymer-foam reconfigurable members may be manufactured such that they are strained (e.g., pre-compressed) to the shape they would assume in the critical configuration, prior to being cut to final shape.

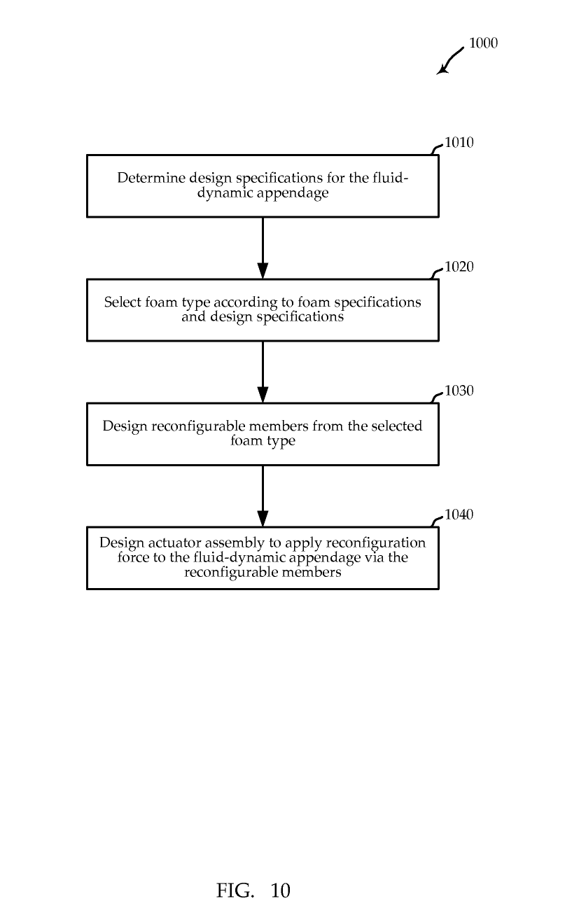

It will now be appreciated that it may be desirable to design and/or manufacture reconfigurable fluid-dynamic structures using a number of reconfigurable and non-reconfigurable members as provided by embodiments of the invention. FIG. 10 provides a flow diagram of a method for designing a reconfigurable fluid-dynamic structure, according to various embodiments of the invention.

The method 1000 begins at block 1010 by determining a set of design specifications for the fluid-dynamic structure. In some embodiments, the design specifications include a reconfiguration direction (e.g., a direction in which the fluid-dynamic structure is designed to be reconfigured), a reconfiguration force (e.g., an amount of force the fluid-dynamic structure is designed to receive in the reconfiguration direction to undergo a reconfiguration), a fluid-dynamic force (e.g., an amount of force the fluid-dynamic structure is designed to experience as a function of a presumed use in a fluid-dynamic environment), a surface integrity (e.g., a maximum allowable amount of fluid-dynamic surface deformation allowed during the presumed use in the fluid-dynamic environment), and/or a reconfiguration dimension (e.g., a dimension of the fluid-dynamic structure oriented in the reconfiguration direction). For example, in one embodiment, the fluid-dynamic structure is designed to reconfigure by extending thirty inches in the span-wise direction under five pounds of reconfiguration force.

In block 1020, a foam type may be selected, at least as a function of a foam specification, to at least partially meet the design specifications determined in block 1010. In some embodiments, the foam specifications include a compliance direction (e.g., a direction in which the foam type is substantially compliant), and a compliance level (e.g., how compliant the foam type is when subjected to a compliance force in the compliance direction). In other embodiments, the foam specification may include other types of parameters, like the amount of tortuosity the foam provides in particular environments.

In block 1030, reconfigurable members are designed according to the selected foam type and design specifications. The reconfigurable members may each have a slice width (e.g., a dimension of the reconfigurable member oriented in the compliance direction). In some embodiments, the slice width is determined based on parameters, including the reconfiguration dimension, the fluid-dynamic force, the surface integrity, the compliance level, and/or the tortuosity. For example, the slice width may be determined as a function of the Poisson equation, or in some other way, to minimize certain surface deformations, like bulging, wrinkling, and necking.

In some embodiments, an actuator assembly is designed at block 1040 to apply the reconfiguration force to the fluid-dynamic structure. In certain embodiments, the reconfiguration force is applied to at least a portion of a plurality of reconfigurable members when the reconfigurable members are coupled with the actuator assembly, such that the compliance direction of the reconfigurable members is aligned with the reconfiguration direction of the fluid-dynamic structure. In other embodiments, the actuator assembly is further adapted to couple with a plurality of non-reconfigurable members, such that the non-reconfigurable members are spaced as a function of the slice width.

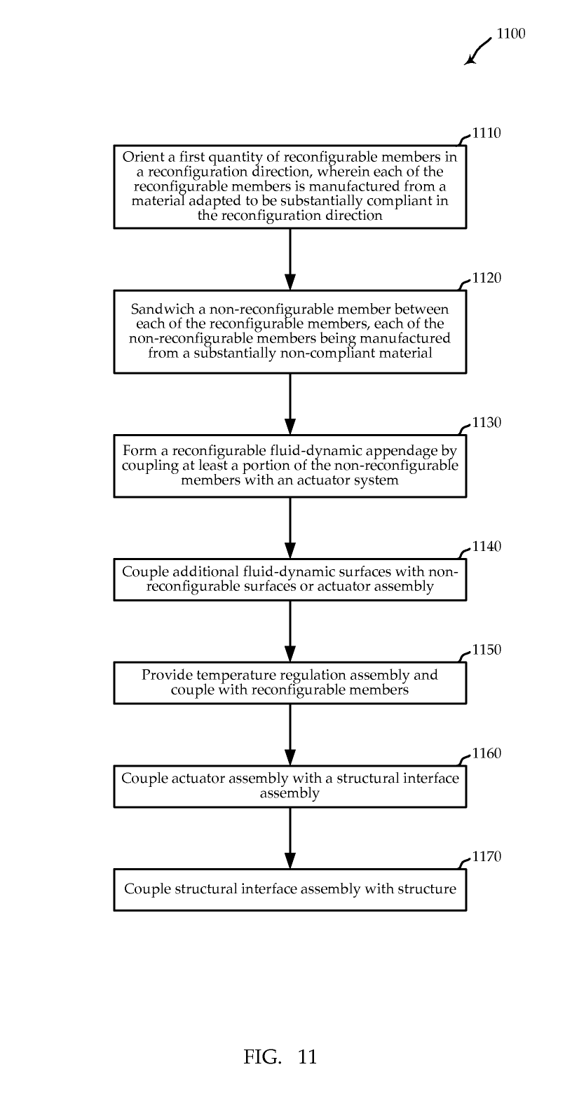

FIG. 11 provides a flow diagram of a method for manufacturing a reconfigurable fluid-dynamic structure, according to various embodiments of the invention. In some embodiments, the method 1100 is used to manufacture a structure similar to the ones shown in FIGS. 2 and 4, and/or a structure designed by the method 1000 of FIG. 10.

The method 1100 begins at block 1110 by orienting a first quantity of reconfigurable members in a reconfiguration direction, wherein each of the reconfigurable members is manufactured from a material adapted to be substantially compliant in the reconfiguration direction. In some embodiments, the reconfigurable members are manufactured from polymeric foam. In certain embodiments, the polymeric foam is first deformed (e.g., compressed or stretched), and then formed into the reconfigurable member while in the deformed state. Embodiments of the reconfigurable members include a fluid-dynamic surface, and may be shaped and/or adapted to form a cross-sectional slice of the reconfigurable fluid-dynamic structure.

At block 1120, a non-reconfigurable member may be sandwiched between each of the reconfigurable members. In certain embodiments, some or all of the reconfigurable members and non-reconfigurable members are laminated together. A reconfigurable fluid-dynamic structure may be formed at block 1130 by coupling at least a portion of the non-reconfigurable members with an actuator system. In some embodiments, the actuator system is adapted to provide a reconfiguration force in the reconfiguration direction. Coupling the portion of the non-reconfigurable members to the actuator system may include configuring the reconfigurable fluid-dynamic structure to transition from a first volumetric shape to a second volumetric shape along the reconfiguration direction when the reconfiguration force is applied by the actuator system. Further, coupling may include attaching and/or sealing in any useful way, as will be appreciated by those of skill in the art.

Embodiments of the method 1100 may include coupling additional components and/or systems with the reconfigurable structure. In some embodiments, additional fluid-dynamic surfaces (e.g., fins, fans, wings, flaps, ailerons, etc.) are coupled with the actuator assembly or other portions of the structure at block 1140. In other embodiments, temperature regulation components are coupled with portions of the structure at block 1150. For example, in one embodiment, the polymeric foam in the reconfigurable members becomes compliant when heated by the temperature regulation components. In yet other embodiments, the actuator assembly and/or other portions of the structure are coupled with a structural interface assembly in block 1160. The structural interface assembly may be adapted to couple the reconfigurable fluid-dynamic structure with a second structure in block 1170. For example, the structural assembly may be configured to attach a reconfigurable wing to a fuselage, etc. In certain embodiments, the structural assembly may further allow certain fluid-dynamic forces to be transferred from the reconfigurable structure into the second structure (e.g., by creating a load path).

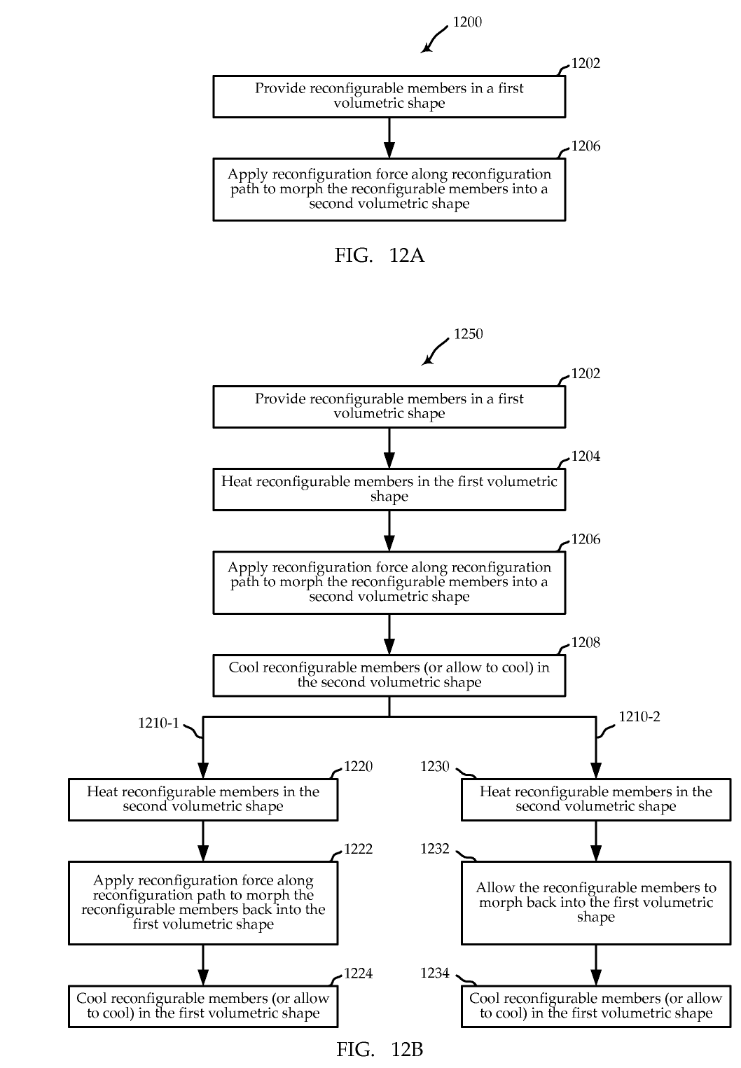

It will be appreciated that a designed and manufactured reconfigurable fluid-dynamic structure (e.g., a structure designed by the method 1000 of FIG. 10 and/or manufactured by the method 1100 of FIG. 11) may be reconfigured in a number of different ways, according to embodiments of the invention. FIGS. 12A and 12B show exemplary flow diagrams of methods for reconfiguring a non-temperature-reactive and a temperature-reactive fluid-dynamic structure, respectively, according to various embodiments of the invention.

In FIG. 12A, the method 1200 begins at block 1202 by providing a reconfigurable structure that includes reconfigurable members in a first volumetric shape. For example, an aircraft wing may be provided in a span-wise shortened configuration, where a portion of the wing is made up of alternating reconfigurable and non-reconfigurable members coupled with an actuator system. At block 1206, the actuator system may apply a reconfiguration force to some or all of the reconfigurable members (e.g., by pulling the span-wise ends of the wing away from each other). This may, in turn, cause the reconfigurable structure to reconfigure (e.g., morph) from the first volumetric shape into a second volumetric shape.

In FIG. 12B, the method 1250 again begins at block 1202 by providing a reconfigurable structure that includes reconfigurable members in a first volumetric shape. Unlike in the method 1200 of FIG. 12A, the reconfigurable members are made of a temperature-sensitive material (e.g., shape-memory polymeric foam). As such, the reconfigurable members may be heated at block 1204 in excess of a reconfiguration threshold temperature, at which temperature they may become compliant.

At block 1206, a reconfiguration force is applied to the reconfigurable members along a reconfiguration path. Applying the reconfiguration force along the reconfiguration path may cause the reconfigurable members to morph from the first volumetric shape into a second volumetric shape (e.g., to stretch). The reconfigurable members may then be cooled (or allowed to cool) at block 1208. After the reconfigurable members cool at block 1208, the reconfigurable members become non-compliant and remain in their second volumetric shape after most, or all, of the applied reconfiguration force has been removed by the actuator system.

Returning the reconfigurable members to their first volumetric shapes may differ depending on whether the foam is or is not shape-memory foam. If the foam is not shape-memory foam (arrow 1210-1), it may or may not need to be first heated back to its compliant state at block 1220. Once in its compliant state, another reconfiguration force may be applied to the reconfigurable members along another (e.g., opposite) reconfiguration path to morph the reconfigurable members back to their first volumetric shapes at block 1222. The reconfigurable members may then be cooled (or allowed to cool) at block 1224. After the reconfigurable members cool at block 1224, the reconfigurable members become non-compliant and remain in their first volumetric shape.

If the foam is shape-memory foam (arrow 1210-2), it may first be heated back to its compliant state at block 1230. The shape memory foam in its compliant state may relax back to its first volumetric shape (e.g., assuming that is its steady-state shape) if no reconfiguration force is applied. As such, the reconfigurable members may be left at block 1232 to relax back to the first volumetric shape. The reconfigurable members may then be cooled (or allowed to cool) at block 1234. After the reconfigurable members cool at block 1234, the reconfigurable members become non-compliant and remain in their first volumetric shape.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

1-22. (canceled)

23. A reconfigurable structure having a comprising:
a plurality of foam members disposed along a reconfiguration direction, wherein each of the foam members comprise a foam that is substantially compliant in the reconfiguration direction;
a plurality of non-foam members sandwiched between a majority of the foam members, wherein the plurality of non-foam members comprise a material that is substantially non-compliant in the reconfiguration direction; and
an actuator coupled with at least one non-foam member and adapted to actuate the reconfigurable structure along the reconfiguration direction between at least a relaxed state, and a compressed state such that in the compressed state the foam members are compressed in the reconfiguration direction and in the relaxed state the foam members are neither stretched nor compressed.

24. The reconfigurable structure according to claim 23, wherein each foam member is coupled with an adjacent non-foam member with an adhesive.

25. The reconfigurable structure according to claim 23, wherein each non-foam member comprises a width less than the compliant member in the relaxed state.

26. The reconfigurable structure according to claim 23, wherein the foam is a polymeric foam.

27. The reconfigurable structure according to claim 23 further comprising a surface coating configured to increase a surface tortuosity of the at least one foam member.

28. The reconfigurable structure according to claim 23 wherein the reconfigurable structure comprises a foam thickness t and a foam width L such that
$$\frac{12 ɛ}{{π}^{2}} ≺ {( \frac{t}{L} )}^{2} .$$

29. The reconfigurable structure according to claim 23 further comprising a heating system configured to heat the plurality of foam members.

30. The reconfigurable structure according to claim 23 further comprising a telescoping member that extends through at least one of the foam members.

31. The reconfigurable structure according to claim 23 wherein the foam members comprises foam with high tortuosity.

32. The reconfigurable structure according to claim 23 wherein the foam members comprise a shape memory foam.

33. A reconfigurable wing, comprising:
a plurality of foam slices with an aerofoil cross section;
a plurality of rigid members with an aerofoil cross section, wherein the rigid members are sandwiched between the plurality of foam slices along a length of the reconfigurable wing; and
an actuator coupled with at least one of the plurality of rigid members, wherein the actuator is configured to move the reconfigurable wing between a first position and a second position along the length of the wing, wherein in the second position the plurality of foam slices are expanded along the length of the wing and the plurality of rigid members maintain their shape.

34. The reconfigurable wing according to claim 33, wherein the plurality of foam slices comprise a shape memory material.

35. The reconfigurable wing according to claim 33 further comprising at least one telescoping member that extends through a majority of the foam slices and a majority of the rigid members.

36. A reconfigurable structure having a comprising:
a plurality of shape memory foam slices disposed along a reconfiguration direction, wherein each of the shape memory foam slices comprises a shape memory foam that is substantially compliant in the reconfiguration direction when heated above a threshold temperature;
a plurality of rigid members, wherein each of the rigid members are sandwiched between two shape memory foam slices, wherein the plurality of rigid members comprise a material that is substantially non-compliant in the reconfiguration direction;
an actuator coupled with at least one rigid member and adapted to actuate the reconfigurable structure along the reconfiguration; and
a heating system configured to heat the plurality of shape memory foam slices above the threshold temperature.

37. The reconfigurable structure according to claim 36, wherein the actuator is configured to compress or stretch at least one shape memory foam slice when actuated.

38. The reconfigurable structure according to claim 36, wherein the heating system comprises electrical heating.

39. The reconfigurable structure according to claim 36, wherein the heating system is configured to heat at least one shape memory foam slice above the threshold temperature prior to reconfiguring the reconfigurable structure.

40. The reconfigurable structure according to claim 36, wherein the heating system is configured to heat at least one shape memory foam slice above the threshold temperature prior to reconfiguring the reconfigurable structure.
